(19) United States
(12) Patent Application Publication
(10) Pub. No.: US 2015/0121827 A1
(43) Pub. Date: May 7, 2015

(54) METHOD OF MAKING POROUS PLUGS IN CERAMIC HONEYCOMB FILTER

(71) Applicant: Dow Global Technologies LLC, Midland, MI (US)

(72) Inventors: Jun Cai, Midland (CN); Ashish Kotnis, Troy (IN); Janet M. Goss, Saginaw, MI (US); Paul C. Vosejpka, Midland, MI (US)

(21) Appl. No.: 14/391,343

(22) PCT Filed: Mar. 7, 2013
(86) PCT No.: PCT/US2013/029584

§ 371 Date: Oct. 8, 2014

Related U.S. Application Data
(60) Provisional application No. 61/664,896, filed on Jun. 27, 2012.

(51) Int. Cl. B01D 46/24; C04B 38/00; C04B 35/64; C04B 35/185

(52) U.S. Cl. CPC B01D 46/244; C04B 35/185; C04B 38/0012; C04B 35/64; C04B 2235/3463
USPC 55/523; 501/1; 264/630

(57) ABSTRACT

A ceramic plugging paste useful to make plugs having through holes (partial plugs) in a ceramic honeycomb filter in which the plugging paste is comprised of a ceramic particulate and fluid carrier, wherein the ceramic particulate has at least 90% by number of the particulates being less than 50 micrometers and the fluid carrier is present in an amount sufficient such that the plugging paste is fluid enough to be inserted into a ceramic honeycomb channel and be retained in said channel without any other support other than the walls of the honeycomb defining the channel. Such a paste may be easily injected in the same manner as regular pastes. Such pastes and methods advantageously realize plugs having a through hole resulting in honeycomb filters having low pressure drop while still retaining effective particulate filtration.

### FIELD OF THE INVENTION

The invention relates to a method of forming plugs in a porous ceramic honeycomb filter. In particular, the invention relates to plugs that have through pathways to reduce back pressure of the ceramic honeycomb filter.

### BACKGROUND OF THE INVENTION

Recently, more stringent regulations of particulate matter emitted by diesel engines and gasoline engines such as gasoline direct injection engines have been passed or are contemplated in Europe and the United States. To meet these regulations, particulate filters generally have been necessary and are anticipated will be necessary.

These particulate filters must meet multiple contradictory exacting requirements. For example, the filter must have sufficient porosity (generally greater than 55 percent porosity) while still retaining most of the emitted micrometer sized diesel particulates (generally greater than 90 percent capture of the emitted particulates). The filter must also be permeable enough so that excessive back pressure does not occur too quickly, while still being able to be loaded with a great amount of soot before being regenerated. The filter must withstand the corrosive exhaust environment for long periods of time. The filter must have an initial strength to be placed into a container attached to the exhaust system. The filter must be able to withstand thermal cycling (i.e., retain adequate strength) from the burning off of the soot entrapped in the filter (regeneration) over thousands of cycles where local temperatures may reach as high as 1600° C. From these stringent criteria, ceramic filters have been the choice of material to develop a diesel particulate filter.

Ceramic filters of sintered cordierite have been explored as a possible diesel particulate filter. Cordierite was explored because of its low cost and use as a three-way catalyst support in automotive exhaust systems. Cordierite filters have been utilized in large truck applications, but have suffered from high backpressures, short life before needing to be cleaned of ash build up and thermal degradation due to localized hot spots.

More recently, silicon carbide has been utilized in light duty diesel engines, mostly because of its ability to withstand more soot than cordierite and its greater thermal stability. Silicon carbide, however, suffers, for example, from having to be sintered at high temperature using expensive fine silicon carbide powder. Because silicon carbide is sintered, the pore structure that develops results in limited soot loading before excessive back pressure develops just as for cordierite.

To remedy the large pressure drops occurring in these filters, filters have been employed having unblocked channels or plugs that have through holes in them such as described in U.S. Pat. Nos. 4,464,185; 6,790,248 and 7,008,461; and PCT publications WO 2011/026071 and WO 2009/148498 and U.S. Pat. Publ. U.S. 2009/0056546 and Japanese patent publications JP2002119867 and JP 1986062216. Generally, the method to create the hole in the plugs has been to machine the desired hole after the plug has been formed. In U.S. Pat. No. 6,790,248 a slurry is attached little by little on the inner surface of the channel of the honeycomb thereby reducing the opening gradually. In U.S. Pat. No. 7,008,461 a method of squirting liquid on the injected paste is described to form a partial plug. These methods suffer from one or more of the following problems, complex or long processing times, uncontrolled plug formation and insufficient adhesion of the plugs.

Accordingly, it would be desirable to provide an improved method of making a plug with one or more through hole(s) (referred to herein as a “partial plug”) that avoids one or more problems of the prior art, such as one of those described above. In addition, it would be desirable to form a partial plug that improves the particulate capture efficiency of unblocked channels or partial plugs described in the prior art.

### SUMMARY OF THE INVENTION

The invention is directed to an improved ceramic honeycomb filter that has partial plugs arising from an improved plugging paste resulting in improved partial plugs. Thus, a first aspect of the present invention is a ceramic particulate and fluid carrier, wherein the ceramic particulate has at least 90% by number of the particulates being less than 50 micrometers and the fluid carrier is present in an amount sufficient such that the plugging paste is fluid enough to be inserted into a ceramic honeycomb channel and be retained in said channel without any other support other than the walls of the honeycomb defining the channel. A second aspect is a ceramic honeycomb plugging paste comprised of a ceramic particulate and fluid carrier, wherein the plugging paste has a volume drying shrinkage of 5% to 80%. A third aspect is a ceramic honeycomb plugging paste comprised of a ceramic particulate and fluid carrier, wherein the plugging paste has a combined volume drying and sintering shrinkage of greater than 25% to 80%. Such pastes allow for easy manufacture of such plugs using existing processing equipment and methods. In addition, such partial filters surprisingly result in desirable adhesion, mechanical integrity and shape of the plugs resulting in improved ceramic honeycomb performance. For example, the push out strength of the partial plugs may be twice the push out strength of full plugs.

A fourth aspect of the invention is method of forming plugs in a ceramic honeycomb comprising,
(a) inserting a paste comprised of a ceramic particulate and carrier fluid into a channel of a ceramic honeycomb to form an initial plug having no through holes,
(b) removing the fluid carrier of said paste such that said initial plug of step (a) forms a dried plug, and
(c) heating to form a sintered plug such that the ceramic particulates of the paste are bonded together and sintered plug is bonded to the walls of the ceramic honeycomb, wherein a through hole is present in said sintered plug.
   The method of aspect 4, surprisingly realizes a honeycomb filter having a partial filter that has desirable partial plugs that decrease partial pressure and have through holes with varying and tortuous paths, which are believed to improve filtration efficiency compared to simple straight bores or through holes that are not as complex.

A final aspect of the invention is a ceramic honeycomb comprised of at least one channel having a plug formed from a paste of this invention at one end of a channel, wherein said plug has a through hole comprised of a central portion and at least one radial spoke extending from the central portion to essentially the surface of a wall defining the channel, wherein the central portion has diameter that is less than 50% of the length of the channel diameter as defined by a circle inscribing said channel.

The ceramic honeycomb filters may be used in any application useful to filter fluids and gases. In particular, they are suited for particulate filters to filter gases arising from internal combustion engines.

### BRIEF DESCRIPTION OF THE DRAWINGS

FIG. 1 is an optical micrograph of a ceramic honeycomb having dried plugs of this invention.

FIG. 2. is an optical micrograph of a ceramic honeycomb having sintered plugs of this invention.

FIG. 3 is a scanning electron micrograph of a sintered plug of this invention showing the small grain size and penetration into the honeycomb wall.

### DETAILED DESCRIPTION OF THE INVENTION

### Plugging Paste

The applicants have discovered a plugging paste that allows for a method for plugging honeycomb filters with partial plugs that is efficient, consistent, uniform and controllable. The paste is comprised of a fluid carrier and ceramic particulate. The fluid carrier may be any liquid that is easily removed by evaporation at lower temperatures (e.g., less than 250° C.) or merely by air drying or vacuum drying at room temperature. Examples include water and any organic liquid, such as an alcohol, aliphatic, glycol, ketone, ether, aldehyde, ester, aromatic, alkene, alkyne, carboxylic acid, carboxylic acid chloride, amide, amine, nitrile, nitro, sulfide, sulfoxide, sulfone, organometallic or mixtures thereof. Desirably, the fluid carrier is water, an aliphatic, alkene or alcohol. The alcohol may be methanol, propanol, ethanol or combinations thereof. Typically, water is used.

The paste is also comprised of a ceramic particulate. The particular chemistry of the ceramic particulate (also referred to as powder) may be any useful for making a ceramic plug that can withstand the operating conditions experienced by a particulate filter in an exhaust system of an internal combustion engine, such as a diesel engine. Exemplary powders include ceramic powders that form ceramics, such as, oxides, carbides, nitrides and combinations thereof. Particular examples include, but are not limited to, silicon carbide, silicon nitride, mullite, cordierite, beta spodumene, phosphate ceramics (e.g., zirconium phosphate) aluminum titanate and precursors that form such compounds upon heating. Preferred examples of ceramics include silica, alumina, aluminum fluoride, clay, fluorotopaz, zeolite, mullite, cordierite and mixtures thereof.

The ceramic powders typically are equiaxed (i.e., have an aspect ratio of less than 2), but are not limited thereto. The ceramic powders typically have morphologies associated with ground powders or powder formed from precipitation processes. Other shapes may be used so long as the plug when inserted into a ceramic honeycomb channel forms a through hole in the plug upon removal of the carrier fluid and sintering the ceramic particulates together.

To create the plugging paste of the invention, it has been discovered in one aspect that the ceramic particulate needs to have at least 90% by number of the particulates to have a size less than 50 micrometers (i.e., d90 particle size). If the particle size is too large or the particles size distribution is broad with too many large particulates, the paste may fail to be able to form the through hole upon removal of the carrier fluid and sintering of the plug while achieving a paste with shear thinning behavior necessary to easily insert the paste into a channel and have it retained in the channel without any other support. The d90 size may desirably be 10, 15, 20, 30 and 40 micrometers. The d90 particle size, however, should not be so small that the amount of fluid carrier necessary to realize a desirable viscosity paste is too great. This generally corresponds to a d90 size of 0.02 micrometers. Even though some of the particles may be larger in size as described above, it is desirable for all of the particles to be less than aforementioned sizes.

Generally, it is desirable for at least a portion (e.g., at least 10% of the particulates) of the ceramic powder to be smaller in size than the average pore size of the walls of ceramic honeycomb. When the ceramic powder is of such a size, it may advantageously impregnate into the wall's pores enhancing the bond between the wall and partial plug. It is worth noting that if the ceramic powder size is too small and the paste is not of a sufficient viscosity, excessive penetration may occur resulting in undesirable amounts of powder being necessary or multiple insertions of the paste to realize a desirable partial plug. Typically, the amount of particulates having a size less than the average pore size of the ceramic honeycomb is at least 25%, 50%, 75% or even 80% by number of the ceramic powder particles.

The particle size of the ceramic powder may be determined by any technique such as those known in the art for the size ranges described herein. Illustrative techniques include, for example, sieving, light scattering, sedimentation and micrographic techniques. It is understood that the size referred to herein is the equivalent spherical diameter of the particles. As to the pore size of the walls of the honeycomb, this may be determined using well known techniques such as mercury porosimetry.

When making the paste, the amount of carrier fluid needs to sufficient to wet the particles and make it fluid enough to be inserted into a channel of a honeycomb but still retain its shape and remain in place without any other support than the honeycomb's walls. Inserted herein means the plugging paste requires a pressure to be applied to facilitate injection into the channel. It understood that the paste requires more than merely pouring it under gravity into the channel. In other words, the paste must be plastically deformed or sheared to become fluid enough to be pumped or injected or vacuum pulled into the channel. Upon being inserted, the plugging paste also must retain its shape without any further support and not merely flow out of the channel as a liquid would. Generally, the requisite viscosity may be obtained when the amount of carrier fluid in the plugging paste is from about 40% to about 95% by volume of the plugging paste. Desirably, the amount of fluid is at least 45%, 50%, 55%, or 60% to at most 90% or 80%.

It is also desirable that the plugging paste exhibit shear thinning behavior to realize a pumpable paste that retains its shape once it has been injected into the channel of the honeycomb. “Shear thinning” means that the viscosity at a higher shear rate is lower than the viscosity at a lower shear rate. Illustratively, the viscosity at a low shear rate (i.e., at 0.5 rpm using a No. 4 disc spindle from a Brookfield RVDV-I Prime viscometer) is typically at least about 50, 100, 200, 350, or even 500 Pa·s, and the viscosity at high shear (i.e., 50 rpm using the same No. 4 disc spindle) is typically at most about 10, 5, 2.5, 1, 0.5, or even 0.1 Pa·s. Such viscosity measurements may be made by viscometer or rheometers for measuring such pastes at such shear rates and viscosities as the one described herein.

The plugging paste may contain other useful components, such as organic additives including, for example, those known in the art of making ceramic pastes. Examples of other useful components include dispersants, deflocculants, flocculants, plasticizers, defoamers, lubricants, binders, porogens and preservatives, such as those described in Chapters 10-12 of Introduction to the Principles of Ceramic Processing, J. Reed, John Wiley and Sons, NY, 1988. When an organic plasticizer is used, it desirably is a polyethylene glycol, fatty acid, fatty acid ester or combination thereof.

Examples of binders include cellulose ethers, such as those described in Chapter 11 of Introduction to the Principles of Ceramic Processing, J. Reed, John Wiley and Sons, NY, N.Y., 1988. Preferably, the binder is a methylcellulose or ethylcellulose, such as those available from The Dow Chemical Company under the trademarks METHOCEL and ETHOCEL. Preferably, the binder dissolves in the carrier liquid.

Porogens are materials specifically added to create pores within the plug after being heated to bond the ceramic particulates together. Typically porogens are any particulates that decompose, evaporate or in some way volatilize away during the heating to leave a pore within the plug. Examples include flour, organic polymers (e.g., polyolefins, latex, nylons, polycarbonate, polyesters and the like), wood flour, starches (e.g., corn starch), carbon particulates (amorphous or graphitic), nut shell flour or combinations thereof.

The plugging paste of this invention desirably has a volume drying shrinkage of 5% to 80%. If the drying shrinkage is too great, the plug may tend to be too friable. If the drying shrinkage is too small, the plug tends not to form a through hole. Typically, the volume drying shrinkage is at least 10%, 15%, 20%, or 25% to 80%, 75%, 70%, 65%, or 60%. Upon removal of the plugging fluid, the dried plug need not have a through hole, but may have just a reduction of mass at the center of the plug that is easily visually visible by shining a light down the channel where the center of the plug visibly is brighter. It is desirable, however, to have a through hole in the dried plug such that stresses and cracking at the interface with the honeycomb wall is avoided due to firing shrinkage of the plug and thermal expansion of the honeycomb.

The volume drying shrinkage may be determined by forming a geometric shape from the plugging paste useful to measure shrinkage and then measuring this initial shape's dimension (initial volume) and then removing the carrier fluid such that the particulates contact one another and further shrinkage does not occur (typically when there is less than about 1% by volume of carrier fluid in the plugging paste is sufficient) and then measuring the dimension of the resultant “dried shape”. The % volume shrinkage is merely:

$$\% V = \frac{( {V}_{in} - {V}_{d} )}{{V}_{d}} * 100$$

where % V is the % volume shrinkage; Vᵢₙ is the initial volume; and V_{d} is the dried volume.

Likewise the plugging paste desirably has a like firing shrinkage as described for the drying shrinkage. It is understood that the firing shrinkage is determined in the same way as described above, except that in the above equation, Vᵢₙ is the volume of the dried volume and V_{d} is the volume of the sintered volume.

When there are through-holes after drying, no sintered shrinkage is needed to form through-holes after sintering to form the sintered plugs, but of course sintered shrinkage may be present, for example, to enlarge a through-hole if desired. When there are no through-holes after drying, a sintered shrinkage of greater than 5% by volume generally is required to form through-holes in the plugs after firing the plugs.

Generally, it has been discovered that the combination of drying and sintered volume shrinkage combined of a paste of this invention (i.e., said shrinkages added together), should be greater than 25% to effectively form the through-holes. The combined volume shrinkage desirably is at least 30%, 40%, or %50 to at most 85%, 80% or 75%.

The plugging paste may be made by any suitable method of creating a slurry, dispersion or paste such as those known in the art. Examples include media milling (e.g., ball or attrition milling), ribbon blending, vertical screw mixing and the like.

### Plugging the Honeycomb

When plugging a ceramic honeycomb using the plugging paste of the invention, the paste is inserted into a channel of the ceramic honeycomb. The ceramic honeycombs may be any suitable porous ceramic, for example, such as those known in the art for filtering Diesel soot. Exemplary ceramics include alumina, zirconia, silicon carbide, silicon nitride and aluminum nitride, silicon oxynitride and silicon carbonitride, mullite, cordierite, beta spodumene, aluminum titanate, strontium aluminum silicates, lithium aluminum silicates. Preferred porous ceramic bodies include silicon carbide, cordierite and mullite or combination thereof. The silicon carbide is preferably one described in U.S. Pat. No. 6,669,751B1 and WO publications EP1142619A1, WO 2002/070106A1. Other suitable porous bodies are described by U.S. Pat. No. 4,652,286; U.S. Pat. No. 5,322,537; WO 2004/011386A1; WO 2004/011124A1; US 2004/0020359A1 and WO 2003/051488A1.

The mullite is preferably a mullite having an acicular microstructure. Examples of such acicular ceramic porous bodies include those described by U.S. Pat. Nos. 5,194,154; 5,173,349; 5,198,007; 5,098,455; 5,340,516; 6,596,665 and 6,306,335; U.S. Patent Application Publication 2001/0038810; and International PCT publication WO 03/082773.

The ceramic making up the honeycomb generally, has a porosity of about 30% to 85%. Preferably, the porous ceramic has a porosity of at least about 40%, more preferably at least about 45%, even more preferably at least about 50%, and most preferably at least about 55% to preferably at most about 80%, more preferably at most about 75%, and most preferably at most about 70%.

The ceramic honeycomb may be a monolithic ceramic honeycomb or honeycomb that is made up of several smaller honeycombs cemented together (segmented honeycomb). The monolithic honeycomb and honeycomb segments making up the segmented honeycomb may be any useful amount, size, arrangement, and shape such as those well known in the ceramic heat exchanger, catalyst and filter art with examples being described by U.S. Pat. Nos. 4,304,585; 4,335,783; 4,642,210; 4,953,627; 5,914,187; 6,669,751; and 7,112,233; EP Pat. No. 1508355; 1508356; 1516659 and Japanese Patent Publ. No. 6-47620. In addition, the monolithic honeycomb or honeycomb segments may have channels with any useful size and shape as described in the just mentioned art and U.S. Pat. Nos. 4,416,676 and 4,417,908. The thickness of the walls may be any useful thickness such as described in the aforementioned and U.S. Pat. No. 4,329,162.

The paste may be inserted into a channel end of the ceramic honeycomb by any useful method for inserting a paste to form an initial plug such as those known in the art including, for example, injecting via a nozzle under pressure, masking an end with openings in the mask to channels which are desired and then pushing by pressure or pulling by vacuum the paste into the channels through the holes in the mask. Further descriptions of such methods are described in the following patents U.S. Pat. Nos. 4,559,193; 4,557,962; 4,715,576; and 5,021,204; U.S. Pat. Appl. Publ. Nos. 2007/0210485 and 2008/0017034 and EP Pat Publ. No. 1586431.

As described earlier it may be desirable to have at least a portion of the ceramic particulates of the plugging paste penetrate into the wall. Even though the ceramic particulates may penetrate through the entire thickness of the honeycomb wall, it typically is desirable, that the particles only penetrate about 50%, 40%, 30%, 20%, 10% or 5% to a fraction of a percent such that the bonding of the plug is enhanced compared to no penetration within the honeycomb wall.

The initial plugs may have a through hole in the plug, but it is preferred that the initial plug is devoid of any through holes. Once the paste has been inserted into a channel end to form an initial plug, the carrier fluid is then removed. The carrier fluid may be removed by any suitable method, such as evaporation, which may be accomplished by evaporation under ambient conditions, under a flowing gas, by heating, vacuum, combination thereof or any other useful method known in the art. The removal of carrier fluid may also occur during heating to remove any organic additives that may be present in the paste or when heating to bond the ceramic particulates of the paste together and to the honeycomb wall. Bond herein, means the sintering (ionic bonding, covalent bonding or combination) of the ceramic particulates together and bonding to the ceramic honeycomb walls.

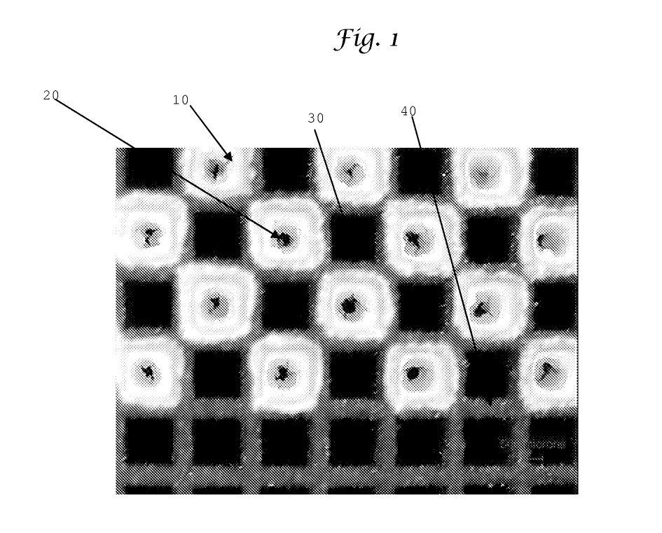

Illustratively, upon removal of the carrier fluid a dried plug 10 is formed in a channel 30 defined by honeycomb walls 40 at one end thereof. The dried plug 10 has a through hole 20 and such through hole 20 is larger than, if present, any through hole in the initial plug. If no through hole is present in the initial plug, the dried plug 10 typically has a through hole upon removal of the carrier fluid. It is understood that mere porosity within the plug is not a through hole, but a through hole 20 is a visually clear pathway from one end of the plug to the other end of the plug as shown in FIG. 1.

After the dried plugs are formed, the honeycomb with the dried plugs is heated to sinter or bond the ceramic particulates of the plugging paste together and to the ceramic honeycomb walls. The time, temperature and atmosphere may be any suitable depending on the particular ceramic honeycomb and ceramic particulates used in plugging paste. Prior to heating to sinter the dried plugs, a separate heating may be conducted to remove any organic additives. The organic additives may also be removed in the same heating cycle when heating to sinter the dried plugs to form the sintered plugs.

Generally, the heating to form the sintered plugs is not so high a temperature that sagging of the ceramic honeycomb structure or other undesired property results (e.g., closing off of porosity, cracking or the like occurs). Typically, the temperature is at least about 600° C., 650° C., 700° C., 750° C. or 800° C. to at most about 2000° C., 1800° C., 1600° C., 1500° C. or 1400° C. The atmosphere may be flowing or static air, vacuum, inert gas, reactive gas, over pressures of gases or combinations thereof. The time at temperature may be any useful time such as 2 to 3 minutes to several days.

The porosity of the plug, ignoring the through hole may be any useful porosity or even fully dense. Preferably, the porosity is as described above for the ceramic honeycomb.

The plug desirably has ceramic grains wherein at least 90% of the grains have a size by number less than about 50 micrometers (d90 of less than 50 micrometers). Even more desirably at least 90% of the grains have a size of less than about 20, 15 or 10 micrometers. It is also desirable for 100% of the grains to be less than aforementioned sizes. It is also desirable if a portion (i.e., at least about 10% by number) of the grains are asymmetric (aspect ratio greater than 2). Desirably, at least 25%, 50%, 75%, 90% or even all of the ceramic grains are asymmetric. It is believed that such asymmetric grains (e.g., acicular or platelet grains) further improve the particulate filtration efficacy.

The grain size and aspect ratio (microstructure) may be determined by known methods such as microscopy on a polished section. For example, the average mullite grain size may be determined from a scanning electron micrograph (SEM) of a polished section of a fracture surface of the sintered plug, wherein the average grain size may be determined by the intercept method described by Underwood in Quantitative Stereology, Addison Wesley, Reading, Mass., (1970).

It is also desirable when forming the sintered plug that the sintered plug shrinks such that a through hole is formed if none is present in the dried plug or the total area of sintered plug through hole is larger than the total area of the dried plug through hole looking down the channel. The total area of the through holes may be determined by known image analysis techniques (black pixels). Generally, the area of the through hole in the sintered plug is at least about 10% greater than the area in the through hole in the dried plug when present. The area may be 15%, 20%, 30% or even 50% larger. Such decreases in area are associated with the firing shrinkages described above for the plugging paste.

The ceramic honeycomb generally has at least one partial sintered plug as described herein. Preferably, at least 10%, 25%, 50%, 75%, 90% or all of the plugs present on each end of the honeycomb are such partial plugs.

### EXAMPLES

### Example 1

42.8 wt % of M200 mullite precursor material (M200 alumina and silica mixture having an Al/Si ratio of 4, available from Ceramiques Techniques & Industrielles S. A., Salindres, France), 0.9 wt % methyl cellulose (METHOCEL A15LV, available from The Dow Chemical Company, Midland, Mich.), and 56.3 wt % of water were mixed for a period of time to make a uniform plugging mud.

The plugging mud was inserted by injecting through a nozzle under pressure into the channels at each end in checkerboard fashion of a mullite ceramic honeycomb available from The Dow Chemical Company, Midland, Mich. under the trademark AERIFY filters. The initial plugs had no holes. In addition, to plugging the honeycomb, the mud was cast into a Teflon mold (148 mm×63 mm×6.5 mm) to form bars that were used to determine the volume drying and firing shrinkages of the mud. The bars were dried and heated to sinter the plugs in the same manner as described below for forming the dried and sintered plugs.

The initial plugs and molded bars were dried at 80° C. in an oven in air for 12 hours. Upon drying (removing the carrier fluid “water”), the honeycomb with the initial plugs had dried plugs having through holes. The honeycomb with dried plugs was heated to a temperature of 1400° C. in air for 6 hours to react the alumina and silica particulates to form mullite grains that are bound together and thus forming the sintered plugs. The sintered plugs had through holes that were visibly larger in area than the through holes in the dried plugs.

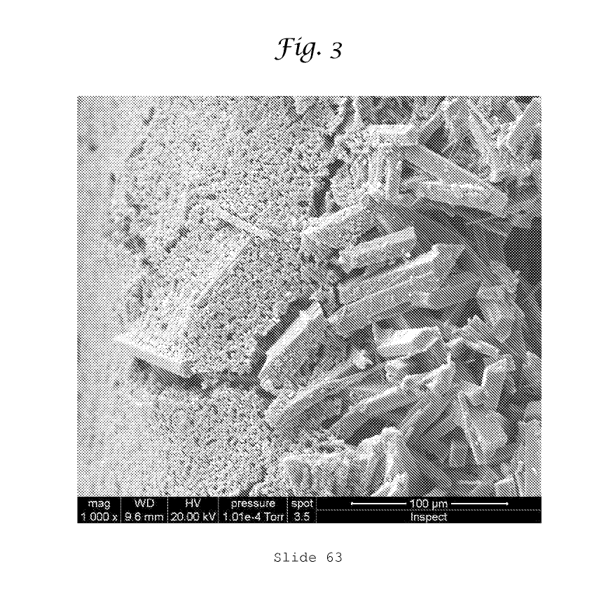

The sintered plugs formed in the honeycomb are shown in FIG. 3. From this Fig. it is apparent that the particulates have penetrated into the wall of the honeycomb (acicular grains on right side of the micrograph) and that the grain size is smaller than the porosity of the honeycomb wall. The d50 and d90 grain size by number as measured by a line intercept method was 2 and 5 micrometers respectively. The properties of the plugging paste and characteristics of the dried and fired plugs formed in the honeycomb are shown in Table 1. The push out strength of the sintered plugs was 11 MPa per mm length of plug. The push out strength was measured by pushing a 1.2 mm diameter round metal pin through plugs and measuring the force necessary to do so.

For soot filtration efficiency evaluation, a 3.1″×3.1″×8″ segment was plugged using the plug mud and fired to 1400° C. The plugged filter was then evaluated for soot filtration efficiency and pressure drop at various soot loadings using a DPG DPF Testing System available from Cambustion Limited, Cambridge, United Kingdom. A master 3.1″×3.1″×8″ segment plugged with standard plugs with no holes was used as a control to measure the soot accumulation rate in a wall flow filter. For these single segments, a programmed soot loading rate of 5 g/hr was used which typically yields an actual soot loading rate of 8-10 g/hr soot. The filtration efficiency can be measured by the following formula:

Filtration Efficiency=

Actual soot accumulation in partial filter segment×100/Soot

accumulation rate in master wall flow filter segment.

The filtration efficiency of the segment plugged with the plug paste in this example was 63%.

### Example 2

In this Example, everything was the same as described for Example 1 except that, 40.0 wt % of M200 mullite precursor material, 0.9 wt % methyl cellulose (METHOCEL A15LV, available from The Dow Chemical Company, Midland, Mich.), and 59.1 wt % of water were mixed well to make uniform plugging mud. In other words, the amount of water was increased and the amount of ceramic particulate was decreased. The dried plugs and sintered plugs had larger through holes than the dried plugs and sintered plugs of Example 1.

The properties of the plugging paste and characteristics of the dried and fired plugs formed in the honeycomb are shown in Table 1. The push out strength of the sintered plugs was 9 MPa per mm length of plug.

### Example 3

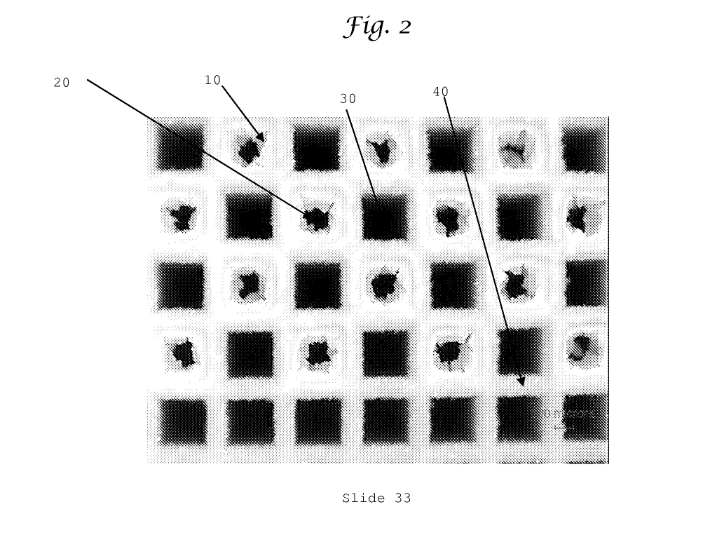

In this Example, everything was the same as described for Example 1 except that, 38.7 wt % of M200 mullite precursor material, 0.9 wt % methyl cellulose and 59.1 wt % of water were mixed well to make uniform plugging mud. In other words, the amount of water was increased compared to Examples 1 and 2 and the amount of ceramic particulate was decreased. The dried plugs and sintered plugs had larger through holes than the dried plugs and sintered plugs of Examples 1 and 2. The dried plugs of this Example are shown in FIG. 1. As can be seen the dried plugs have through holes. The sintered plugs of this Example are shown in FIG. 2. From visible comparison of FIGS. 1 and 2 it is apparent that the through hole size in the sintered plugs are larger than the through holes in the dried plugs.

The properties of the plugging paste and characteristics of the dried and fired plugs formed in the honeycomb are shown in Table 1. The push out strength of the sintered plugs was 7 MPa per mm length of plug.

### Example 4

In this Example, everything was the same as described for Example 1 except that, 20.0 wt % of M200 mullite precursor material, 5.3 wt % methyl cellulose and 74.7 wt % of water were mixed well to make uniform plugging mud. In other words, the amount of water was increased compared to Examples 1-3 and the amount of ceramic particulate was decreased. The dried plugs and sintered plugs had larger through holes than the dried plugs and sintered plugs of Examples 1-3.

The properties of the plugging paste and characteristics of the dried and fired plugs formed in the honeycomb are shown in Table 1. The filtration efficiency of the segment plugged with the plug paste in this example was 33%.

### Example 5

In this Example, everything was the same as described for Example 1 except that, 15.4 wt % of M200 mullite precursor material, 6.0 wt % methyl cellulose and 78.6 wt % of water were mixed well to make uniform plugging mud. In other words, the amount of water was increased compared to Examples 1-4 and the amount of ceramic particulate was decreased. The dried plugs and sintered plugs had larger through holes than the dried plugs and sintered plugs of Examples 1-4.

The properties of the plugging paste and characteristics of the dried and fired plugs formed in the honeycomb are shown in Table 1. The filtration efficiency of the segment plugged with the plug paste in this example was 18%.

### Example 6

In this Example, everything was the same as described for Example 1 except that, 50.3 wt % of M100 mullite precursor material (M100 powder, available from Ceramiques Techniques & Industrielles S. A., Salindres, France), 1.1 wt % methyl cellulose (METHOCEL A15LV, available from The Dow Chemical Company, Midland, Mich.), and 48.6 wt % of water were mixed well to make uniform plugging mud. The M100 mullite precursor material is a mixture of the following materials: 25.35 wt % ball milled clay (EUBC01 Hywite Alum, available from Ceramiques Techniques & Industrielles S. A., Salindres, France), 46.40 wt % alumina powder (CTIKA01, available from Ceramiques Techniques & Industrielles S. A., Salindres, France), and 25.35 wt % kaolin powder (EUBC03 Argical-C 88R, available from Ceramiques Techniques & Industrielles S. A., Salindres, France), 0.30 wt % iron oxide (Fe-601, available from Atlantic Equipment Engineers, Bergenfield, N.J.), 2.60 wt % raw talc (WC&D raw talc MB50-60, available from Applied Ceramics, Atlanta, Ga.). The chemical composition of mullite precursor is 69.7 wt % of Al₂O₃, 27.3 wt % of SiO₂, 1.0 wt % MgO, 1.0 wt % of Fe₂O₃, 0.6 wt % of TiO₂, 0.3 wt % of K₂O, and 0.1 wt % of CaO.

The sintered plugs had through holes that were visibly larger in area than the through holes in the dried plugs. The properties of the plugging paste and characteristics of the dried and fired plugs formed in the honeycomb are shown in Table 1. The push out strength of the sintered plugs was 8 MPa per mm length of plug.

### Comparative Example 1

In this Example, everything was the same as described for Example 1 except that 57.3 wt % of mullite powder (MULCOA 70, 325 mesh powder from C. E. Minerals, King of Prussia, Pa.), 5.2 wt % of nutflour porogen (WF-7 walnut shell flour available from Agrashell Inc., Los Angeles, Calif.), 1.3 wt % methyl cellulose (METHOCEL A15LV, available from The Dow Chemical Company, Midland, Mich.), and 36.2 wt % of water were mixed well to make uniform plugging mud.

The initial plugs, dried plugs and sintered plugs did not have any through holes. The properties of the plugging paste and characteristics of the dried and fired plugs formed in the honeycomb are shown in Table 1. The push out strength of the sintered plugs was 3 MPa per mm length of plug. The filtration efficiency of the segment plugged with the plug paste in this example was 99%.

### Comparative Example 2

In this Example, everything was the same as described for Example 1 except that 55.1 wt % of mullite powder (MULCOA 70, 325 mesh powder from C. E. Minerals, King of Prussia, Pa.), 5.8 wt % of M200 mullite precursor material (M200 alumina and silica mixture, available from Ceramiques Techniques & Industrielles S. A., Salindres, France), 6.7 wt % of Nylon 12 powder (Vestosint 2155 Natural, available from Evonik Degussa Corporation, Leesport, Pa.), 1.1 wt % methyl cellulose (METHOCEL A15LV, available from The Dow Chemical Company, Midland, Mich.), and 31.4 wt % of water were mixed well to make a uniform plugging mud.

The initial plugs, dried plugs and sintered plugs did not have any through holes. The properties of the plugging paste and characteristics of the dried and fired plugs formed in the honeycomb are shown in Table 1. The push out strength of the sintered plugs was 5 MPa per mm length of plug. The filtration efficiency of the segment plugged with the plug paste in this example was 99%.

From the data in Table 1 and the Figures, it is apparent that the plugging paste of this invention is capable of making through holes efficiently and effectively with desirable morphologies (complex tortuous pathways). In addition, the push out strength of the sintered plugs of the Examples is at least the same as that of the plugs of the Comparative Examples even though these plugs have through-holes.

TABLE 1

| | | | Ceramic | | | Volume | Volume | | | | |
|---|---|---|---|---|---|---|---|---|---|---|---|
| | Ceramic | Ceramic | Solid | η at 0.5 | η at 50 | Drying | Firing | | | Plug Strength | Filteration |
| | Particulate | Particulate | Loading | rpm (Pa- | rpm (Pa- | Shrinkage | Shrinkage | Dried | Sintered | Per mm length | Efficiency |
| Ex. | d50 (μm) | d90 (μm) | (wt %) | Sec) | Sec) | (%) | (%) | Hole | Hole | of Plug (MPa/mm) | (%) |
| 1 | 2.3 | 7.8 | 42.8% | 253 | NA | 26% | 27% | yes | yes | 11 | 63% |
| 2 | 2.3 | 7.8 | 40.0% | 158 | 3.72 | 28% | 36% | yes | yes | 9 | |
| 3 | 2.3 | 7.8 | 38.7% | 69 | 1.48 | 28% | 34% | yes | yes | 7 | |
| 4 | 2.3 | 7.8 | 20.0% | NA | 1.70 | | | yes | yes | | 33% |
| 5 | 2.3 | 7.8 | 15.4% | NA | 1.51 | | | yes | yes | | 18% |
| 6 | 12 | 40 | 50.3% | NA | 2.12 | 27% | 27% | yes | yes | 8 | |
| Comp. 1 | 62 | 135 | 57.3% | NA | 1.97 | 20% | 5% | no | no | 3 | 99% |
| Comp. 2 | 34 | 114 | 60.9% | NA | 2.25 | 23% | 1% | no | no | 5 | 99% |

d50 = median particle size by number
d90 = 90% by number of particles are smaller.
η = viscosity

1. A ceramic honeycomb plugging paste comprised of a ceramic particulate and fluid carrier, wherein the ceramic particulate has at least 90% by number of the particulates being less than 50 micrometers and the fluid carrier is present in an amount sufficient such that the plugging paste is fluid enough to be inserted into a ceramic honeycomb channel and be retained in said channel without any other support other than the walls of the honeycomb defining the channel.

2. The plugging paste of claim 1, wherein the paste has a volume drying shrinkage of at least 5%.

3. The plugging paste of claim 1, wherein the plugging paste is comprised of one or more organic additives.

4. The plugging paste of claim 3, wherein the organic additive is a surfactant, porogen, binder or combination thereof.

5. The plugging paste of claim 1, wherein the amount of fluid carrier is at least 40% to 90% by volume of the plugging paste.

6. The plugging paste of claim 1, wherein said plugging paste is shear thinning.

7. The plugging paste of claim 2, wherein the plugging paste has a volume sintering shrinkage of at least 5% and a combined volume drying and sintering shrinkage of greater than 25%.

8. The plugging paste of claim 1, wherein 100% of the ceramic particulate particles are less than 50 micrometers.

9. A method of forming plugs in a ceramic honeycomb comprising,
(a) inserting a plugging paste comprised of a ceramic particulate and carrier fluid into a channel of a ceramic honeycomb to form an initial plug having no through holes,
(b) removing the fluid carrier of said paste such that said initial plug of step (a) forms a dried plug, and
(c) heating to form a sintered plug such that the ceramic particulates of the paste are bonded together and sintered plug is bonded to the walls of the ceramic honeycomb, wherein the sintered plug has a through hole therein.

10. The method of claim 9 wherein a portion of the ceramic particulates of the plugging paste penetrate into a porous wall defining the channel of the ceramic honeycomb.

11. The method of claim 9, wherein the dried plug has a through hole therein.

12. The method of claim 11, wherein the sintered through hole of the sintered plug has a greater area than the through hole of the dried plug.

13. A ceramic honeycomb made by the method of claim 9.

14. A ceramic honeycomb comprised of at least one channel having a plug at one end of a channel, wherein said plug has through hole comprised of ceramic grains such that at least 90% of the grains have a size by number less than about 50 micrometers.

15. The ceramic honeycomb of claim 14, wherein at least a portion of the grains have an aspect ratio of greater than 2.

16. The ceramic honeycomb of claim 15, wherein 90% of the grains have a size of less than 15 micrometers.

17. A ceramic honeycomb plugging paste comprised of a ceramic particulate and fluid carrier, wherein the ceramic particulate has at least 90% by number of the particulates being less than 50 micrometers and the fluid carrier is present in an amount of at 40% to 90% by volume of the plugging paste.

18. A ceramic honeycomb plugging paste comprised of a ceramic particulate and fluid carrier, wherein the plugging paste has a volume drying shrinkage of 5% to 80%.

19. A ceramic honeycomb plugging paste comprised of a ceramic particulate and fluid carrier, wherein the plugging paste has a combined volume drying and sintering shrinkage of greater than 25% to 80%.

20. The method of claim 9, wherein the plugging paste has a combined volume drying and sintering shrinkage of greater than 25%.
